(19) United States
(12) Patent Application Publication
(10) Pub. No.: US 2026/0306332 A1
(43) Pub. Date: Oct. 8, 2026

(54) SURGICAL TABLE WITH INTEGRATED ABSOLUTE SENSORS

(71) Applicant: American Sterilizer Company, Mentor, OH (US)

(72) Inventors: John M. Kasunich, Mayfield Heights, OH (US); David Jesurun, South Euclid, OH (US)

(73) Assignee: American Sterilizer Company, (US)

(21) Appl. No.: 19/478,988

(22) PCT Filed: May 14, 2024
(86) PCT No.: PCT/US2024/029233

§ 371 Date: Oct. 27, 2025

Related U.S. Application Data
(60) Provisional application No. 63/466,497, filed on May 15, 2023.

(51) Int. Cl. A61G 13/08

(52) U.S. Cl. CPC A61G 13/08; A61G 2203/36

(57) ABSTRACT

A surgical table for supporting a patient during a medical procedure includes a first support section, a first absolute sensor attached to the first support section, and a controller communicatively coupled to the first absolute sensor. The controller is configured to receive from the first absolute sensor first data corresponding to the first support section, and determine from the first data at least one of a motion of the first support section, an orientation of the first support section, or a change in position of the first support section. The controller is further configured to modify control of the surgical table based on the determined motion, orientation, or change in position of the first support section.

### CLAIM OF PRIORITY AND CROSS-REFERENCE TO RELATED APPLICATIONS

This application claims priority to U.S. Provisional Patent Application Ser. No. 63/466,497, filed on May 15, 2023, entitled “SURGICAL TABLE WITH INTEGRATED ABSOLUTE SENSORS,” which is incorporated by reference herein in its entirety.

### FIELD OF THE INVENTION

The present invention relates generally to surgical tables and the like, and more particularly, to a surgical table having absolute sensors for detecting a position, orientation and/or motion of portions of the surgical table relative to earth.

### BACKGROUND OF THE INVENTION

Modern surgical tables have some degree of automated motion control that relies on actuators with various types of feedback from conventional relative sensors, such as encoders, proximity (non-contact) and limit (contact) switches located throughout the table. These sensors work by detecting the continuity or discontinuity of an electrical circuit. Such sensors are typically on or near the actuators or mechanisms that move the various components.

While feedback from conventional switches and sensors is sufficient for basic motion control, these sensors only provide relative position and orientation information and cannot provide information that is not directly caused by the actuators themselves. In other words, these sensors do not provide absolute position.

### SUMMARY OF THE INVENTION

More detailed knowledge of the location and orientation of table components would enable additional useful features in surgical tables, particular in how the tables are controlled. Aspects of the present invention are directed to a surgical table that includes absolute sensors integrated with surfaces and/or sections of the surgical table. Such absolute sensors, which work by detecting an effect produced by the interaction of the device with the earth's gravitational and/or magnetic fields, enable detection of position, orientation, and motion of the surfaces/sections relative to the earth, rather than relative to other parts of the surgical table. Including absolute sensors in the surgical table enables detection of the table tipping, flexing or drifting under load, the table being placed on an uneven floor surface, and orientation of the band control. The inventive concept includes not only the presence of such absolute sensors in the table, but also their integration with the table control system to provide enhanced safety, performance, and ease of use.

According to one aspect of the invention, a surgical table for supporting a patient during a medical procedure includes: a first support section; a first absolute sensor attached to the first support section; and a controller communicatively coupled to the first absolute sensor and configured to: receive from the first absolute sensor first data corresponding to the first support section, determine from the first data at least one of a motion of the first support section, an orientation of the first support section, or a change in position of the first support section, and modify control of the surgical table based on the determined motion, orientation, or change in position of the first support section.

In one embodiment, the controller is configured to modify the control of the surgical table to compensate for deflection of the first support section due to a load applied to the first support section.

In one embodiment, the controller is configured to implement collision avoidance between the first support section and another support section or a surface to which the surgical table is mounted, and wherein the controller is configured to alter parameters used for the collision avoidance based on the detected motion, orientation or change in position of the first support section.

In one embodiment, the controller is configured to modify the control of the surgical table to compensate for motion or deflection due to an external force applied to the first support section.

In one embodiment, the controller is configured to modify the control of the surgical table based on the data received from the first absolute sensor to automatically calibrate at least one parameter of the surgical table.

In one embodiment, the first support section includes a first support surface, and the at least one parameter includes a level of the first surface.

In one embodiment, the first absolute sensor includes a plurality of absolute sensors attached to the first support surface.

In one embodiment, the first absolute sensor includes one of an accelerometer, a gyroscope, an inclinometer, or a magnetometer.

In one embodiment, the first support section includes one of a head section for supporting the patient's head, a back section for supporting the patient's upper torso, a seat section for supporting the patent's lower torso, a leg section for supporting the patient's legs/lower body, a column section for supporting the head, back, seat, and leg sections, and a base section for supporting the column section.

In one embodiment, the surgical table includes: a second support section; and a second absolute sensor attached to the second support section, wherein the controller is communicatively coupled to the second earth sensor, and wherein the controller is configured receive from the second absolute sensor second data corresponding to the second support section, determine from the second data at least one of a motion of the second support section an orientation of the second support section, or a change in position of the second support section, and modify control of the surgical table based on the determine motion, orientation, or change in position of the second support section.

According to another aspect of the invention, a method for controlling a surgical table having a first support section, and a first absolute sensor attached to the first support section is provided. The method includes determining from data provided by the first absolute sensor at least one of a motion of the first support section, an orientation of the first support section, or a change in position of the first support section, and modifying control of the surgical table based on the determined motion, orientation, or change in position of the first support section.

In one embodiment, modifying the control of the surgical table includes compensating for deflection of the first support section due to a load applied to the first support section.

In one embodiment, the method includes implementing collision avoidance between the first support section and another support section or a surface upon which the surgical table is supported, and modifying parameters used when implementing collision avoidance on the detected deflection of the first support section.

In one embodiment, modifying the control of the surgical table includes compensating for an external force applied to the first support section.

In one embodiment, modifying the control of the surgical table includes automatically calibrating at least one parameter of the surgical table based on the data received from the first absolute sensor.

In one embodiment, calibrating the at least one parameter includes a parameter corresponding to a level of the first surface.

In one embodiment, the surgical table includes a second support section, and a second absolute sensor attached to the second support section, the method including determining from data provided by the second absolute sensor at least one of a motion of the second support section, an orientation of the second support section, or a change in position of the second support section, and modifying control of the surgical table based on the determined motion, orientation, or change in position of the second support section.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof.

FIG. 1 is a perspective view of a surgical table according to an exemplary embodiment of the present invention.

FIG. 2 is an exploded view of the surgical table of FIG. 1, including seat and back sections, and attachable leg and head sections.

FIG. 3 shows a hand-held primary user control (also referred to as the primary hand control) of the surgical table, including keypad and display unit.

FIG. 4 is a block diagram of an exemplary control system of the surgical table of FIG. 1.

FIG. 5 is a flow chart illustrating exemplary steps of a method for detecting uncommanded motion of a surgical table using data from absolute sensors in accordance with the invention.

FIG. 6 is a flow chart illustrating exemplary steps of a method for calibrating sensors and leveling a surgical table using data from absolute sensors in accordance with the invention.

FIG. 7 is a flow chart illustrating exemplary steps of a method for orienting a graphical display of the surgical table using data from absolute sensors in accordance with the invention.

FIG. 8 is a flow chart illustrating exemplary steps of a method for compensating for flexing of the surgical table using data from absolute sensors in accordance with the invention.

FIG. 9 is a flow chart illustrating exemplary steps of a method for stabilizing a surface of the surgical table using data from absolute sensors in accordance with the invention.

### DETAILED DESCRIPTION OF PREFERRED EMBODIMENT

Aspects of the present invention will now be described with reference to the drawings, wherein like reference numerals are used to refer to like elements throughout. Such aspects may be embodied in many different forms and should not be construed as limited to the embodiments set forth herein; rather, these embodiments are provided so that this disclosure will be thorough and complete, and will fully convey its scope to those skilled in the art. Further, it will be understood that the figures are not necessarily to scale.

The word “about” when immediately preceding a numerical value means a range of plus or minus 10% of that value, e.g., “about 50” means 45 to 55, “about 25,000” means 22,500 to 27,500, etc., unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

In accordance with the invention, one or more absolute sensors are incorporated in sections of the surgical table, the absolute sensors operative to measure one or more of an absolute location, absolute orientation, and/or absolute motion of the surfaces to which the absolute sensors are attached. As used herein, the term “earth sensor” is defined as a sensor that measures one or more of position, orientation, or motion relative to the earth, which may be considered an absolute measurement, rather than relative to other parts of the surgical table. Examples of absolute sensors include accelerometers, gyroscopes, magnetometers, inclinometers, and the like. These sensors work by detecting a change in linear or angular momentum produced by applied external forces. For example, an accelerometer measures the rate of change of linear motion, which can be integrated to determine relative linear speed and displacement. A gyroscope measures the rate of change of angular motion, which can be integrated to determine relative angular speed and displacement A compass measures orientation relative to the earth's magnetic pole.

By attaching absolute sensors to the sections of the surgical table, additional information is provided to a controller of the surgical table, and this information can be used to improve overall control of the surgical table. For example, three accelerometers arranged orthogonal to each other can provide three-dimensional information. Similarly, use of an inclinometer and/or gyroscope can improve the accuracy of the measured tilt angle, e.g., by removing errors introduced by external accelerations that are not detected by the “actuator” sensors. The information provided by the absolute sensors can be used by the controller to detect, for example, tipping of the table, flexing of the tabletop or drifting under load, the table being on an uneven floor surface, and/or orientation of the hand control unit relative to the table.

An essential performance aspect of a surgical table is that there should be no unwanted movement, even in the case of a fault. Typically, some movement can be detected by conventional sensors, such as limit switches, encoders and proximity switches. However, in the presence of hardware or software failures, it is possible that patient support surfaces move without triggering these sensors. In these cases, an integrated absolute sensor can provide data used by the controller to detect such uncommanded motion, and the controller then can take action to prevent such uncommanded motion, compensate in some way for the uncommanded motion, or at least provide a notification to the user that such uncommanded motion has occurred.

An extreme instance of unwanted motion is the entire surgical table tipping over. Since the entire table may move as a solid body, this cannot be detected by the relative motion of various table components. However, the absolute sensors attached to portions of the surgical table can provide data indicative of such tipping motion. Even if the real-time detection of such an event cannot prevent it from occurring, the knowledge that it occurred can be useful in investigating the cause and prescribing corrective actions for such an event.

The controller also can use data provided by the absolute sensors to perform an automatic calibration procedure. Surgical tables may need to be calibrated prior to use, and such calibration may drift over time due to a variety of reasons. Calibration conventionally involves receiving some user input, such as an independently measured position or orientation of the surface being calibrated, or confirmation when a component is level or at a specified position or inclination. Calibration may also be based on assumptions, like assigning level to be when the motion is halfway between two extremes. The use of absolute sensors enables calibration to be completed based on automated and absolute measurement of these quantities, thereby avoiding user input and assumptions.

The data provided by the absolute sensors can also be used to perform deflection compensation. More specifically, patient support surfaces may deflect under the weight of the patient. As surgical patients get heavier, these deflections can be as much as a few inches. In such cases, a “level” command may not result in a perfectly level patient. Absolute sensors attached to the table can enable tabletop positioning that accounts for the deflection of the patient support surface.

Yet another enhancement in control of the table through absolute sensors is collision avoidance. Collision avoidance prevents tabletop sections from colliding with other parts of the table or with their surroundings, such as the floor. This advanced capability is based on the table's knowledge of its current spatial position. While the relative motion of tabletop sections may be known through the use of conventional sensors, the effect of deflection on possible collisions can be considered if the position of tabletop components is directly measured using integrated absolute sensors. This can improve the accuracy, and therefore the usefulness, of the collision avoidance feature.

A surgical table employing absolute sensors in accordance with the invention can also perform stabilization of patient support surfaces. More particularly, patient support surfaces may move under the influence of dynamic external forces during a surgical procedure, such as surgical staff members leaning on the patient or directly on the table, or by intentionally applied loads for therapeutic or diagnostic purposes. In many such cases, it is not desired, and may even be unsafe, for the patient to move. A surgical table equipped with integrated absolute sensors may be able to actively compensate for the effect of these dynamic loads to effectively stabilize the patient's position. Conceptually, this is similar to image stabilization for a camera or noise cancelling speakers in which automated responses to measured perturbations maintain a more stable environment In surgery, active compensation to stabilize the patient's position while exposed to varying mechanical load may be especially important in robotic surgery and interoperative imaging, including image-guided surgery.

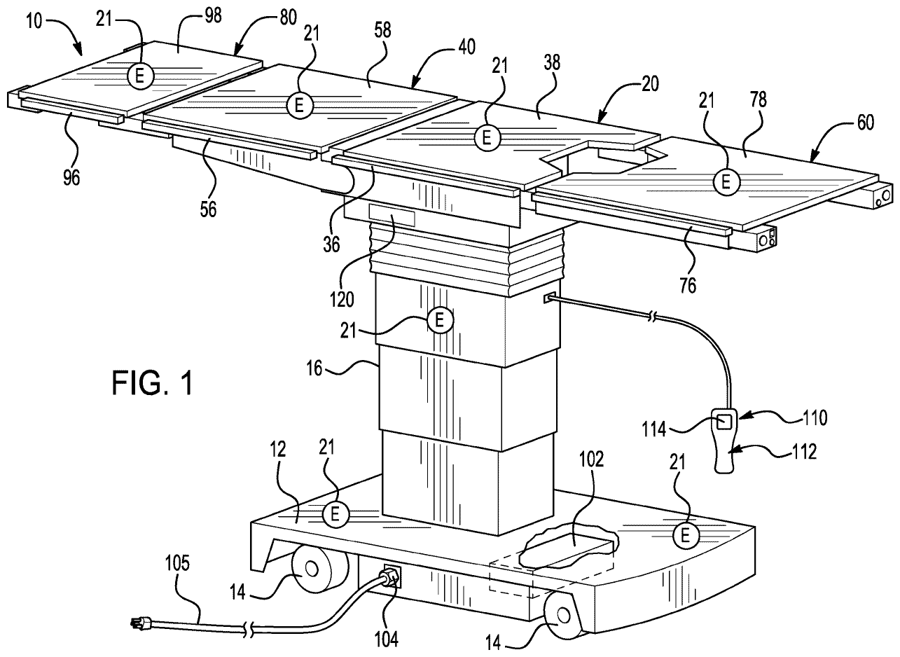

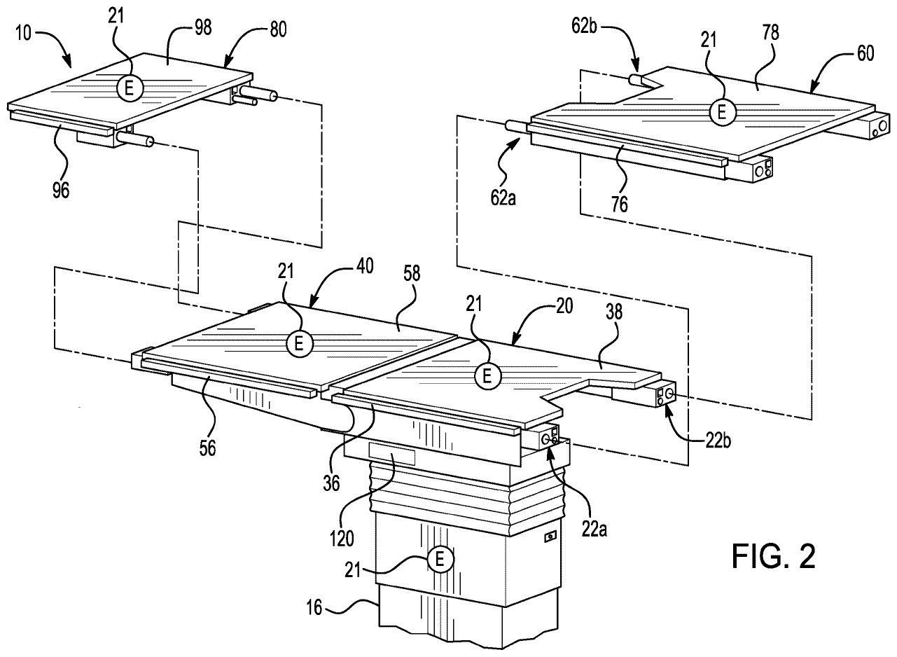

Referring now to FIGS. 1 and 2, illustrated is a representative surgical table 10 according to an embodiment of the present invention. It should be appreciated that surgical table 10 can take alternative physical forms that may be similarly adapted according to the present invention. In the illustrated embodiment, surgical table 10 includes a base 12, a column portion 16, and a main platform comprised of a moveable seat section 20 permanently mounted to column portion 16. A moveable back section 40 is permanently mounted to the movable seat section 20, a movable leg section 60 is selectively amounted to the movable seat section 20, and a movable head section 80 is selectively mounted to the back section 40. As will be discussed in further detail below, one or more of the table sections, i.e., the base 12, the column portion 16, the movable seat section 20, movable back section 40, the movable leg section 60, and the movable head section 80 includes a respective absolute sensor 21. It will be appreciated that each section may have more than one absolute sensor 21. Multiple absolute sensors per section may be advantageous, for example, to provide redundancy and/or to confirm the accuracy of the other sensor(s) associated with the respective section.

With continued reference to FIGS. 1 and 2, base 12 has a plurality of wheels 14 to facilitate movement of surgical table 10, and engageable/disengageable floor locks (not shown) to lock the position of surgical table 10. A power system 100 including a rechargeable battery 102 and a mains power receptacle 104, for connecting surgical table 10 to a mains power source via a power cord 105, are housed within base 12. In the illustrated embodiment, and as described in further detail below, base 12 also houses a table controller that provides overall system control of surgical table 10.

Column portion 16 includes a lift system (not shown) for adjusting the height of surgical table 10. In this regard, the lift system adjusts the height of the main platform (also referred to as the tabletop) of surgical table 10 (i.e., seat section 20 and back section 40 which are both mounted to column portion 16).

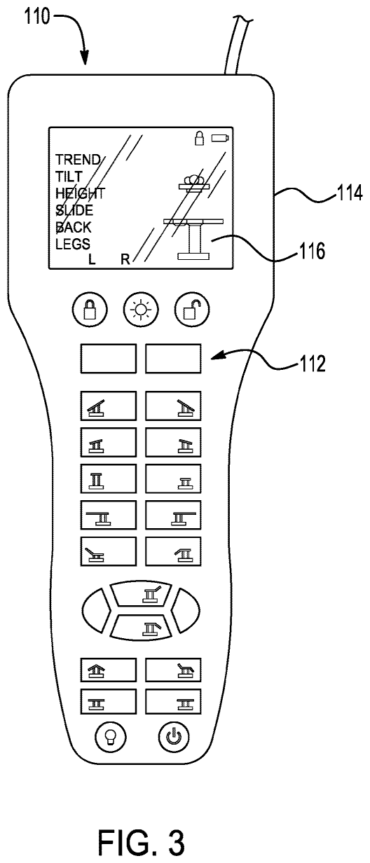

A primary user control 110 in the form of a wired handheld control unit is connected to the table controller via a wired connection in the illustrated embodiment, but may also be connected to the table controller via a wireless connection. As best seen in FIG. 3, the exemplary primary user control 110 includes a keypad 112 for user control inputs and a display 114 that provides surgical table information to the user, including a table image 116, which is discussed in further detail below. The illustrated embodiment of surgical table 10 also includes a secondary user control 120 mounted to column 16 that is electrically connected to the table controller. In one example, secondary user control 120 includes a keypad that is the same or similar to the keypad 112 of primary user control. In another example, the secondary user control 120 may include a display substantially the same as display 114 of primary user control.

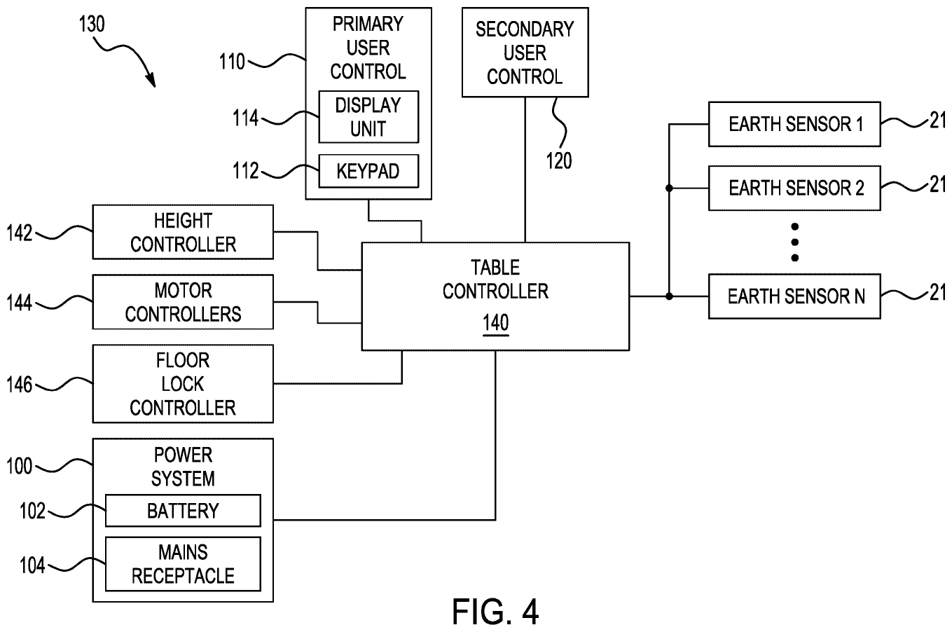

A general description of control system 130 of surgical table 10 according to an embodiment of the present invention will now be described with reference to FIG. 4 before providing a detailed description of the table operation. Control system 130 includes a table controller 130 for providing overall system control of surgical table 10. Table controller 130 comprises a processing unit and a memory device. Control system 30 further comprises a height controller 142 for controlling the height of column portion 16, a plurality of motor controllers 144 for controlling motors that move table 10 to various desired positions (e.g., movement of trend, tilt, up/down, head slide, slide foot, back up, back down, leg up, leg down, left leg, right leg, flex, beach chair, kidney up, and kidney down), a floor lock controller 146 for locking the floor position of table 10, power system 100 comprised of rechargeable battery 102 and mains power receptacle 104 for connection to mains power, primary user control user 110, and secondary user control 120. In the illustrated embodiment, control system 130 also includes one or more absolute sensors 21 attached to each section of the table 10, the absolute sensors 21 communicatively coupled to the table controller 130 to provide data to the controller 130. While in the illustrated embodiment each section includes an absolute sensor 21, it will be appreciated that in other embodiments some sections may not have an absolute sensor and/or some sections may have more than one absolute sensor. As described in further detail below, the table controller 130 uses the data from the absolute sensors 21 to modify control of the table 10.

Referring back to FIGS. 1 and 2, seat section 20 is comprised of a support surface 38 and a pair of lateral side rails 36 for mounting of attachable components. As best seen in FIG. 2, seat section 20 also includes a pair of mechanical interfaces 22a and 22b located at the free distal end thereof. Mechanical interfaces 22a and 22b are comprised of the mechanical elements for connecting an attachable component (described below) to the distal end of seat section 20. Back section 40 includes a support surface 58 and a pair of lateral side rails 56. The free distal end of back section 40 includes mechanical interfaces that are similar to the mechanical interfaces 22a, 22b of seat section 20.

In the illustrated embodiment, leg section 60 is comprised of a support surface 78 and pair of lateral side rails 76. As best seen in FIG. 2, leg section 60 also includes a pair of mechanical interfaces 62a and 62b located at the free distal end thereof. Mechanical interfaces 62a and 62b are comprised of mechanical elements for attaching leg section 60 to the distal end of seat section 20 described above. In the illustrated embodiment, mechanical interfaces 62a and 62b are each generally comprised of an elongated post dimensioned to be received by a mating socket of seat section 20, and an elongated locking pin dimensioned to be received by latch receptacle of seat section 20.

A second attachable component in the form of head section 80 will now be briefly described with reference to FIGS. 1 and 2. Head section 80 is comprised of a support surface 98 and a pair of lateral side rails 96. In addition, head section 80 includes mechanical interfaces that are similar to the same as mechanical interfaces 62a, 62b of leg section 60, and thus, are not described in further detail herein.

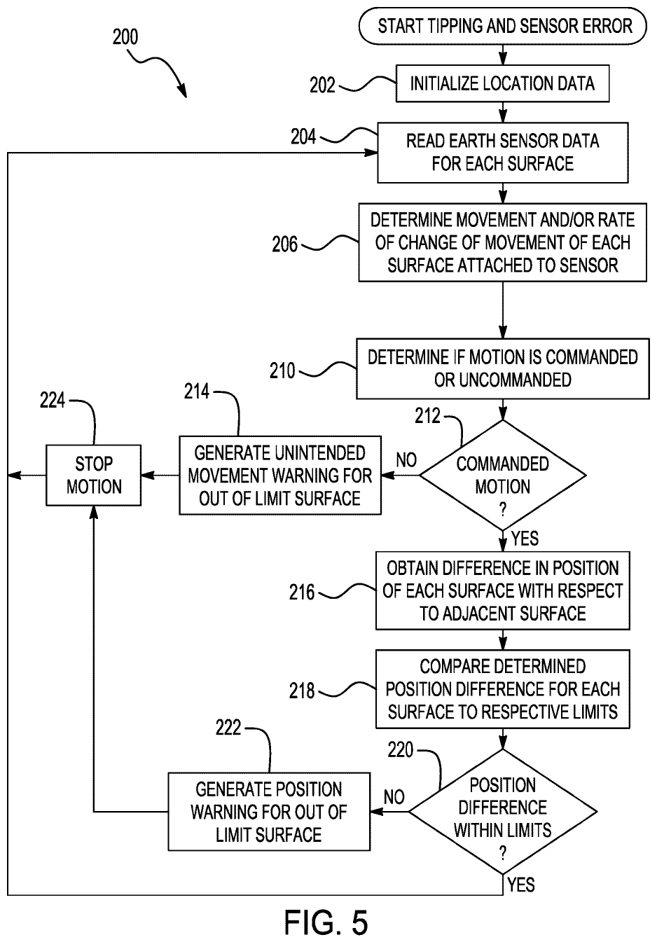

With reference to FIGS. 5-9, illustrated are various flow charts that provides exemplary steps for utilizing the absolute sensors 21 to augment control of a surgical table 10 in accordance with the invention. The steps illustrated in the flow charts may be executed, for example, by the controller 130, to control operation of the surgical table 10. The flow charts includes a number of process blocks arranged in a particular order. As should be appreciated, many alternatives and equivalents to the illustrated steps may exist and such alternatives and equivalents are intended to fall with the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

Beginning with FIG. 5, illustrated is a flow chart 200 utilizing an absolute sensor 21 to detect uncommanded motion of the surgical table 10. Such uncommanded motion, for example, may be due to tipping of the table 10, a fault in a specific section, or the section being overloaded. Beginning at step 202, the controller 130 initializes location data for each surface to which each absolute sensor 21 is attached. Such initial location may be based on data obtained from the conventional “actuator” sensors while the table 10 is unloaded and in a known state. At step 204 the controller 130 reads the data from each absolute sensor 21, and at step 206 the controller 130, based on the data provided by each absolute sensor 21, determines if the section has moved and/or a rate of change in movement rate of the respective surface.

At step 210 the determined motion/rate of change of motion is analyzed by the controller 130 to determine if the motion is uncommanded motion. For example, if motion is detected but the controller 130 has not commanded any motion, then the motion may be regarded as uncommanded motion. In some instances, motion may be commanded yet the detected motion may be considered uncommanded. For example, if the controller 130 commands the table 10 to tilt but, due to loading, the table tips over, such motion may be regarded as uncommanded motion even though the controller 130 was commanding motion. To detect uncommanded motion when the controller 130 is commanding motion, the rate of change of the motion, the direction of the motion, the particular sections that are undergoing motion, etc. can be analyzed to see if the detected motion corresponds to the commanded motion. If the detected motion does not correspond to the commanded motion or is moving too fast, then such motion is deemed to be uncommanded motion. At step 212 if the motion is determined to not be commanded motion (i.e., it is uncommanded motion), then at step 214 the controller 130 generates a warning that uncommanded motion has occurred and the method moves to step 224 where motion of the section is inhibited, if possible. The method then moves back to step 204 and repeats.

Moving back to step 212, if the motion is determined to be commanded motion, then the method moves to step 216 where the controller 130 determines the relative position change for adjacent sections. For example, the position of each section can be based on the movement/rate of change of movement as determined at step 206 along with the initial location of the respective section(s) as determined at step 202. The position of each section then can be compared to the position of each adjacent section to obtain the relative position difference for adjacent sections. At step 218 the position difference for each section relative to the adjacent section is compared to respective limits. At step 220, if the change in position relative to the immediately adjacent section is not within limits (e.g., if a section is experiencing or has undergone uncommanded motion), then at step 222 the controller 130 generates a warning that one or both sections are out of position and the method moves to step 224 where motion for the section(s) is inhibited. Moving back to step 220, if the position difference between adjacent sections is within limits, no action is required and the method moves back to step 204 and repeats.

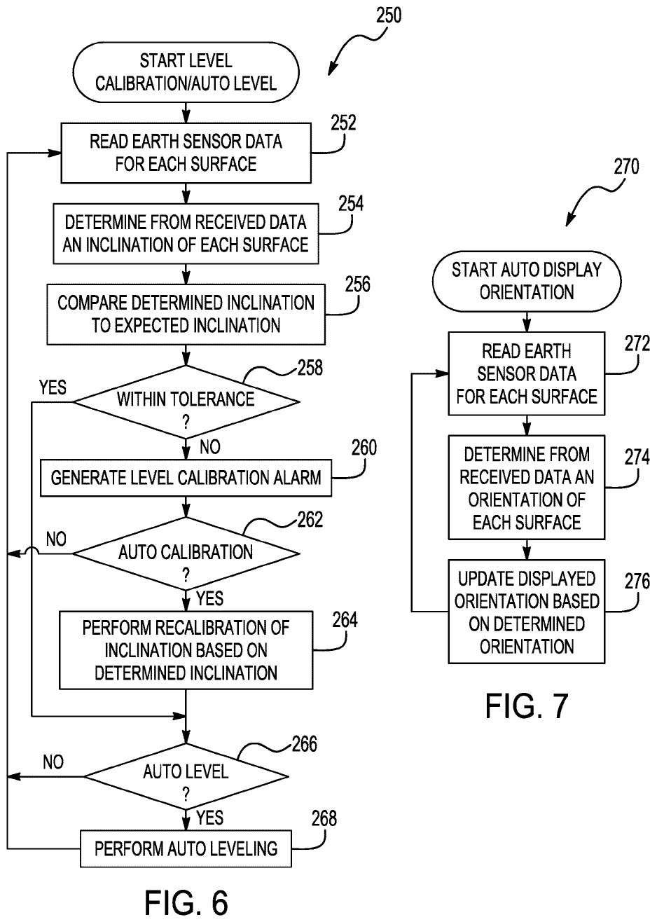

Moving now to FIG. 6, illustrated is a flow chart 250 utilizing an absolute sensor 21 to automatically calibrate at least one parameter of the surgical table, such as a parameter corresponding to a level of the first surface. For example, an absolute sensor 21 in the form of an inclinometer can be used to detect if sensor calibration is required and to determine if the table is level. Beginning at step 252, the controller 130 reads data from the absolute sensor 21, and at step 254 the controller 130 determines from the data an inclination of the surface to which the absolute sensor is attached. At step 256 the controller 130 compares the inclination of the surface as determined in step 254 to an expected inclination of the surface, where the expected inclination is based on data provided by sensors fixed to the surgical table sections, e.g., one or more encoders or the like. At step 258, if the expected inclination and the determined inclination are within a preset tolerance, then no correction is required and the method moves to step 266. However, if the expected inclination and the determined inclination are not within the preset tolerance, then the method moves to step 260 where a calibration warning is generated. Next the method then moves to step 262 where the controller 130 determines if automatic calibration is enabled. Such automatic calibration may be set, for example, by a user via the primary user control 110. If automatic calibration is not enabled, the method moves back to step 252 and repeats, while if automatic calibration is enabled the method moves to step 264 where a recalibration is performed. Such recalibration may include, for example, updating parameters within the controller 130 based on data provided by the absolute sensor 21.

Moving to step 266, the controller determines if an auto level command has been issued. Such command may be input, for example, by a user via the primary user control 110. If an automatic level command is not received, the method moves back to step 252. However, if an auto level command is received, the method moves to step 268 and an auto leveling procedure is performed. Such auto leveling may include, for example, commanding the surface being calibrated to a level position based on data provided by the absolute sensor 21. The method then moves back to step 252 and repeats.

Referring now to FIG. 7, illustrated is a flow chart 270 utilizing an absolute sensor 21 to detect an orientation of the table 10 and, based on the detected orientation, update a graphical display 114 on the primary user control 110. For example, the table 10 may be rotated relative to the primary user control 110 thereby changing the orientation of the table 10 relative to the display 114 of the primary user control 110. This change in orientation can be detected and used to update the display 114. Beginning at step 272, the controller 130 reads data from the absolute sensor 21 and at step 274 the controller 130 determines an orientation of the surgical table 10 based on the data provided by the absolute sensor 21. At step 276, the controller 130 updates a graphical representation of the surgical table 10 on the display 114 based on the orientation of the table 10 as determined in step 274. The method then moves back to step 272 and repeats.

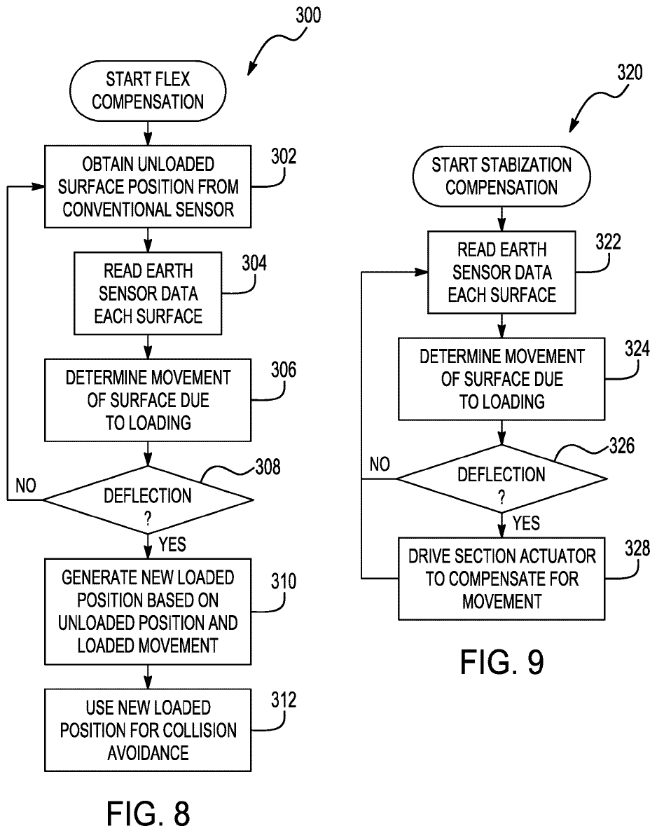

Moving to FIG. 8, illustrated is a flow chart 300 utilizing an absolute sensor 21 to determine if the table 10 is flexing under load and if so, modify parameters used for collision avoidance based on the detected flexing, e.g., to avoid a collision between a first section of the table and another section of the table 10 and/or the floor to which the surgical table 10 is mounted. Beginning at step 302, the controller 130 obtains an unloaded surface position from conventional sensors fixed between sections of the table and/or the sensors attached to actuators for the respective sections, e.g., encoders and the like. The unloaded surface position is the position of the table surfaces with no load placed on them, i.e., without a patient, medical personnel, or an object on or touching the surfaces of the table 10. Next at step 304 the controller 130 reads data from the absolute sensors 21 and at step 306 the controller determines if there is any movement of the surface due to loading. For example, if a surface is flexing the absolute sensor 21 may provide acceleration data or inclination data to the controller 130, which then can calculate how much the surface is flexing. At step 308 if flexing has not occurred then no parameters need updating and the method moves back to step 302 and repeats. However, if flexing has occurred then the method moves to step 310 where the controller 130 generates a new “loaded” position for the section(s) based on the unloaded position obtained in step 302 and the movement of the section determined in step 306. The new loaded position then is used for collision avoidance as indicated at step 312.

Finally, FIG. 9 illustrates is a flow chart 320 utilizing an absolute sensor 21 for purposes of stabilizing a surface of the table 10 to compensate for an external force applied to the surface or other part of the table 10. For example, as a patient is lying on the table 10 the surfaces are in a steady state and thus do not move. In the event the patient is moved, e.g., rolled over, or a surgeon leans on the table, the table surface may unintentionally move (e.g., the column may compress or portions of the table may flex). By detecting such movement, the controller 130 can actively move portions of the table to compensate for such flexing. For example, if the column 16 begins to compress, the controller 130 can command the height controller 142 to return the column 16 to the original height. Beginning at step 322, the controller 130 reads data from the absolute sensor 21, and at step 324 the controller 130 determines if there is movement of the table surface. At step 326, if no movement is detected, the method moves back to step 322. However, if movement is detected then the method moves to step 328 where the controller 130 commands a section of the table 10 to move in a manner that compensates for the unintended motion of that section. The method then moves back to step 322 and repeats.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

1. A surgical table for supporting a patient during a medical procedure, comprising:
a first support section;
a first absolute sensor attached to the first support section; and
a controller communicatively coupled to the first absolute sensor and configured to:
receive from the first absolute sensor first data corresponding to the first support section,
determine from the first data at least one of a motion of the first support section, an orientation of the first support section, or a change in position of the first support section, and
modify control of the surgical table based on the determined motion, orientation, or change in position of the first support section.

2. The surgical table according to claim 1, wherein the controller is configured to modify the control of the surgical table to compensate for deflection of the first support section due to a load applied to the first support section.

3. The surgical table according to claim 1, wherein the controller is configured to implement collision avoidance between the first support section and another support section or a surface to which the surgical table is mounted, and wherein the controller is configured to alter parameters used for the collision avoidance based on the detected motion, orientation or change in position of the first support section.

4. The surgical table according to claim 1, wherein the controller is configured to modify the control of the surgical table to compensate for motion or deflection due to an external force applied to the first support section.

5. The surgical table according to claim 1, wherein the controller is configured to modify the control of the surgical table based on the data received from the first absolute sensor to automatically calibrate at least one parameter of the surgical table.

6. The surgical table according to claim 5, wherein the first support section includes a first support surface, and the at least one parameter comprises a level of the first surface.

7. The surgical table according to claim 1, wherein the first absolute sensor comprises a plurality of absolute sensors attached to the first support surface.

8. The surgical table according to claim 1, wherein the first absolute sensor comprises one of an accelerometer, a gyroscope, an inclinometer, or a magnetometer.

9. The surgical table according to claim 1, wherein the first support section comprises one of a head section for supporting the patient's head, a back section for supporting the patient's upper torso, a seat section for supporting the patent's lower torso, a leg section for supporting the patient's legs/lower body, a column section for supporting the head, back, seat, and leg sections, and a base section for supporting the column section.

10. The surgical table according to claim 1, further comprising:
a second support section; and
a second absolute sensor attached to the second support section, wherein the controller is communicatively coupled to the second earth sensor, and wherein the controller is configured
receive from the second absolute sensor second data corresponding to the second support section,
determine from the second data at least one of a motion of the second support section, an orientation of the second support section, or a change in position of the second support section, and
modify control of the surgical table based on the determine motion, orientation, or change in position of the second support section.

11. A method for controlling a surgical table having a first support section, and a first absolute sensor attached to the first support section, the method comprising determining from data provided by the first absolute sensor at least one of a motion of the first support section, an orientation of the first support section, or a change in position of the first support section, and modifying control of the surgical table based on the determined motion, orientation, or change in position of the first support section.

12. The method according to claim 11, wherein modifying the control of the surgical table includes compensating for deflection of the first support section due to a load applied to the first support section.

13. The method according to claim 12, comprising implementing collision avoidance between the first support section and another support section or a surface upon which the surgical table is supported, and modifying parameters used when implementing collision avoidance on the detected deflection of the first support section.

14. The method according to claim 11, wherein modifying the control of the surgical table includes compensating for an external force applied to the first support section.

15. The method according to claim 11, wherein modifying the control of the surgical table includes automatically calibrating at least one parameter of the surgical table based on the data received from the first absolute sensor.

16. The method according to claim 15, wherein calibrating the at least one parameter includes a parameter corresponding to a level of the first surface.

17. The method according to claim 11, wherein the surgical table includes a second support section, and a second absolute sensor attached to the second support section, the method comprising determining from data provided by the second absolute sensor at least one of a motion of the second support section, an orientation of the second support section, or a change in position of the second support section, and modifying control of the surgical table based on the determined motion, orientation, or change in position of the second support section.
